(19) United States
(12) Patent Application Publication
(10) Pub. No.: US 2026/0359409 A1
(43) Pub. Date: Nov. 12, 2026

(54) INFORMATION PROCESSING SYSTEM, INFORMATION PROCESSING METHOD, AND PROGRAM

(71) Applicant: NEC Corporation, Tokyo (JP)

(72) Inventors: Yuki YAMAHIRO, Tokyo (JP); Koui NORIMATSU, Tokyo (JP); Yasuo YANAGAWA, Tokyo (JP)

(73) Assignee: NEC Corporation, Tokyo (JP)

(21) Appl. No.: 19/142,248

(22) PCT Filed: Dec. 28, 2022
(86) PCT No.: PCT/JP2022/048536

§ 371 Date: Jun. 23, 2025

(51) Int. Cl. G06F 21/32; G06Q 10/0832

(52) U.S. Cl. CPC G06F 21/32; G06Q 10/0832

(57) ABSTRACT

An information processing system includes: an acquisition portion that acquires biometric information about a subject; an authentication portion that authenticates the subject by using the acquired biometric information about the subject; and a control portion that causes information pertaining to an authentication result of the subject to be output to a delivery person who delivers a certificate that possesses biometric information about the subject.

### TECHNICAL FIELD

The present disclosure relates to an information processing system, an information processing method, and a program.

### BACKGROUND ART

In recent years, the use of information processing systems has made it possible to apply for various procedures online and to receive the documents accompanying the application, simplifying the application and delivery procedures.

Under such circumstances, from the viewpoint of security, it is required that the issuance of certificates such as passports be completed at the counter of a prescribed institution that issues the certificate. Applicants are required to perform the application process at the designated authority responsible for issuing the certificate and to collect the issued certificate at that office. As a result, it was not possible to collect passports and other certificates at any place other than the designated institution's counter.

### PRIOR ART DOCUMENTS

### Patent Documents

Patent Document 1: International Patent Publication PCT No. 2021/19229

### SUMMARY OF INVENTION

### Problems to be Solved by the Invention

This disclosure is intended to improve upon the technique disclosed in the prior art document.

Therefore, an example object of the present invention is to provide an information processing system, an information processing method, and a program that can solve the above-mentioned problem.

### Means for Solving the Problem

An information processing system according to a first example aspect is an information processing system includes: an acquisition portion that acquires biometric information about a subject; an authentication portion that authenticates the subject by using the acquired biometric information about the subject; and a control portion that causes information pertaining to an authentication result of the subject to be output to a delivery person who delivers a certificate that possesses biometric information about the subject.

An information processing method according to a second example aspect is an information processing method includes the process of: acquiring biometric information about a subject; authenticating the subject by using the acquired biometric information about the subject; and causing information pertaining to an authentication result of the subject to be output to a delivery person who delivers a certificate that possesses biometric information about the subject.

A program according to a third example aspect is a program for causing a computer to execute the steps of: acquiring biometric information about a subject; authenticating the subject by using the acquired biometric information about the subject; and causing information pertaining to an authentication result of the subject to be output to a delivery person who delivers a certificate that possesses the biometric information about the subject.

### BRIEF DESCRIPTION OF DRAWINGS

FIG. 1 is a schematic configuration diagram of an information processing system 1 according to the example embodiment.

FIG. 2 is a diagram for explaining a case of applying for a passport according to the example embodiment.

FIG. 3A is a flowchart of a process for applying for a passport according to the example embodiment.

FIG. 3B is a flowchart of a process for applying for a passport according to the example embodiment.

FIG. 4 is a configuration diagram of a delivery person terminal device 400 and a delivery information processing device 500 according to the example embodiment. FIG. 5 is a diagram for explaining the delivery process according to the example embodiment.

FIG. 6A is a diagram for explaining the delivery authentication process according to the example embodiment.

FIG. 6B is a flowchart of a delivery authentication process according to the example embodiment.

FIG. 7A is a diagram for explaining a certificate according to the example embodiment.

FIG. 7B is a diagram for explaining a certificate according to the example embodiment.

FIG. 8 is a diagram for explaining authentication processing (self-authentication processing) for a delivery person according to the example embodiment.

FIG. 9 is a flowchart of an authentication process for a delivery person according to the example embodiment.

FIG. 10A is a diagram for explaining the use of a certificate including biometric information of an applicant according to the example embodiment.

FIG. 10B is a flowchart of an applicant authentication process (part 1) according to the example embodiment.

FIG. 11 is a flowchart of a delivery destination authentication process according to the example embodiment.

FIG. 12 is a flowchart of applicant authentication processing (part 2) according to the second example embodiment.

FIG. 13A is a configuration diagram of a delivery person terminal device 400A and a management device 300A according to the third example embodiment.

FIG. 13B is a diagram for explaining a delivery process according to the third example embodiment.

FIG. 14 is a diagram for explaining applicant authentication processing according to the fourth example embodiment.

FIG. 15 is a diagram for explaining application processing according to the fourth example embodiment.

FIG. 16 is a diagram for explaining a payment process according to the fifth example embodiment.

FIG. 17 is a diagram for explaining a payment process according to the fifth example embodiment.

FIG. 18 is a diagram illustrating an example of a configuration of an information processing system according to the sixth example embodiment.

FIG. 19 is a flowchart showing an example of a processing procedure of an information processing method according to the sixth example embodiment.

FIG. 20 is a schematic block diagram illustrating a computer configuration according to at least one example embodiment.

### EXAMPLE EMBODIMENT

An information processing system according to an example embodiment will be described below with reference to the drawings. The following description is intended to explain example embodiments of the present disclosure, and is not intended to limit the present disclosure to the following example embodiments. For clarity of explanation, the following description has been omitted and simplified as appropriate. Furthermore, each element of the following example embodiments can be easily modified, added, or converted within the scope of this disclosure.

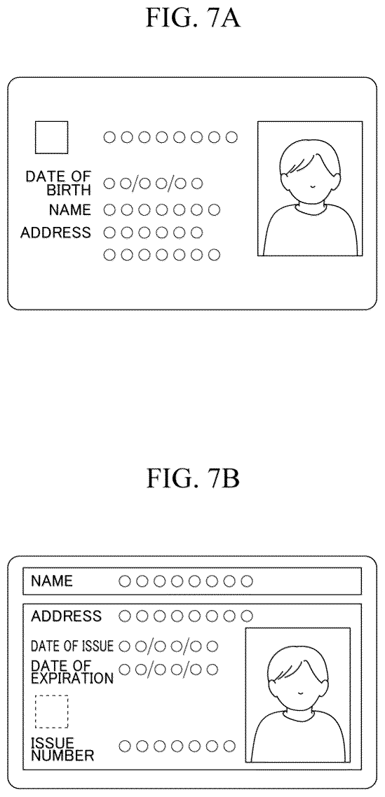

Certificates are used to officially identify the holder. Examples of such certificates include a passport, a health insurance card, a residence card, a personal identification card (FIG. 7A), a driver's license (FIG. 7B), and a driver's license history certificate. If this certificate contains the biometric information of the holder, the following method can be applied. The biometric information of the holder may be a facial photograph (facial information) printed on the surface of the certificate, or information stored as data in a storage section of the certificate formed as an IC card. In the following description, the acquisition of a passport will be taken as an example, but the present disclosure is not limited to this and can be applied to other types of certificates. In the following description of the example embodiment, a case will be exemplified in which a certificate (second certificate) other than a passport is used when receiving a passport (first certificate) by delivery. In this case, it is advisable for the passport applicant to possess a certificate (second certificate) other than the passport that has already been issued when he or she is about to receive a passport (first certificate).

If a person does not possess a certificate other than a passport (a second certificate), it is advisable to switch to an authentication method that does not use a second certificate, for example by informing the person in advance at the application stage.

### First example embodiment

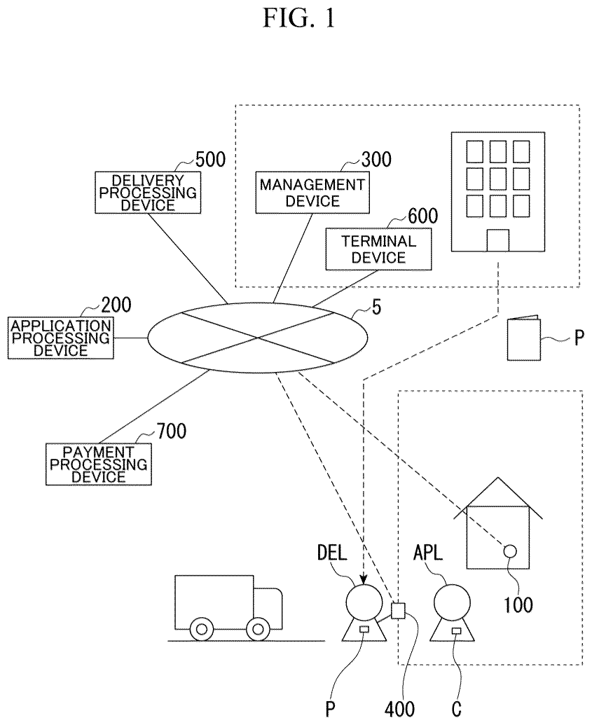

An information processing system 1 according to an example embodiment will be described with reference to FIGS. 1 to 11.

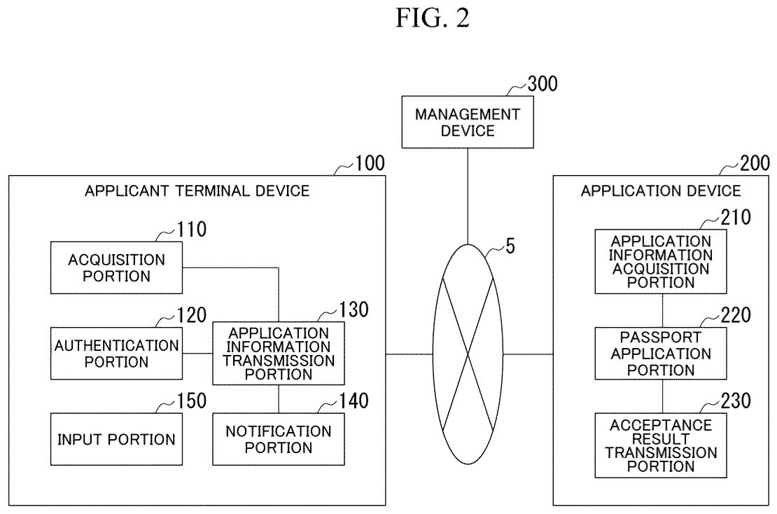

FIG. 1 is a schematic configuration diagram of an information processing system 1 according to an example embodiment. FIG. 2 is a diagram for explaining a case of applying for a passport according to the example embodiment.

This information processing system 1 makes it possible to deliver a passport issued based on an application to an applicant APL (hereinafter, sometimes simply referred to as the applicant). This passport will be delivered by a delivery person DEL (hereinafter, sometimes simply referred to as the delivery person).

The information processing system 1 includes, for example, an applicant terminal device 100, an application processing device 200, a management device 300, a delivery person terminal device 400, a delivery information processing device 500, a terminal device 600, and a payment processing device 700. The applicant terminal device 100, the application processing device 200, the management device 300, the delivery person terminal device 400, the delivery information processing device 500, the terminal device 600, and the payment processing device 700 are each connected to a network and configured to be able to communicate via the network. It should be noted that the payment processing device 700 does not necessarily have to be included in the information processing system 1 of this example embodiment. A description of the payment processing portion 700 is provided below.

The applicant terminal device 100 is an information device including a communication-enabled computer, such as a smartphone or a personal computer. The applicant terminal device 100 transmits the information required for the passport application to the application processing device 200 in response to the detected operation of the applicant. This information includes the name, address, biometric information (image information such as a facial image), and birthday that can identify the applicant. This applicant terminal device 100 may be one that is possessed by the applicant.

The application processing device 200 accepts the passport application from the applicant terminal device 100. In response to the application from the applicant terminal device 100, the application processing device 200 transmits the passport application including the photograph of the applicant of the passport, individual number, and other information among the received information to the management device 300 in order to verify the applicant's information.

In this way, by communicating with both the applicant terminal device 100 and the management device 300, the application processing device 200 can return to the applicant terminal device 100 a response from the management device 300 in response to the request from the applicant terminal device 100.

The management device 300 is, for example, an administrative agency that issues passports (hereinafter, also referred to as a “passport issuing agency”).

The management device 300 receives inquiries about information related to passport applications and verifies the information. If the result of matching the information is good, the passport will be issued. If a passport is issued, the management device 300 responds to the application from the application processing device 200 and returns the screening result to the applicant terminal device 100. This completes the passport application.

Furthermore, the management device 300 arranges for the production of a passport as a process required for issuing the passport. In this way, when the passport application is approved, the management device 300 starts various processes for issuing a passport.

After this, the applicant can collect the issued passport at the passport issuing agency's counter or have it delivered. The applicant may be able to select whether to collect the issued passport at the counter of the passport issuing institution or by delivery, or it may be preset so that the passport is automatically collected by delivery without any selection being required. In the latter case, it is possible to omit the action of the applicant performing a designation.

In this example embodiment, a case will be described in which the reception of the passport by delivery or the like is selected.

For example, the delivery of passports is entrusted to a delivery company that undertakes delivery services. Without being limited thereto, delivery may be made by the passport issuing authority. In the following description, an example of outsourcing the delivery operation to a delivery company will be described.

The delivery company will then use a delivery person to deliver the passport to a specific address designated by the delivery service contracted. This allows applicants to collect their passports at the location where they previously applied.

As described above, the delivery person terminal device 400 is an information device including a computer, such as a smartphone or a personal computer. This delivery person terminal device 400 is carried by the delivery person. The delivery person uses the delivery person terminal device 400 to receive information necessary for delivering the passport and performs the passport delivery work.

The delivery person terminal device 400 acquires the information generated by the management device 300 via the delivery information processing device 500. The information generated by the management device 300 includes information related to the passport delivery schedule, information related to the issuance of passports for delivery, and the like. The delivery information processing device 500 acquires the information generated by the management device 300 and stores it in the storage portion 460. When the delivery person terminal device 400 detects an operation by the deliveryman, it acquires and outputs information stored in the storage portion 540 of the delivery information processing device 500.

By appropriately operating the delivery person terminal device 400, the delivery person can view information related to the passport delivery plan, information related to the issuance of the passport to be delivered, and the like, which are held in the storage portion 540 of the delivery information processing device 500. These operations can be performed at any time.

In this way, the delivery information processing device 500 can return information to the delivery person terminal device 400 in response to a request from the delivery person terminal device 400 by communicating with both the delivery person terminal device 400 and the management device 300.

A more specific configuration example of each of the above devices will be described below.

### Applicant Terminal Device

First, the applicant terminal device 100 according to the present example embodiment will be described with reference to FIGS. 1 to 3A.

As shown in FIG. 2, the applicant terminal device 100 has an acquisition portion (imaging portion) 110, an authentication portion 120, an application information transmission portion 130, and a notification portion 140. The acquisition portion 110 acquires a facial photograph of a passport applicant. The authentication portion 120 obtains the individual number of the passport applicant. Here, the individual number refers to a number used to identify a specific individual in administrative procedures.

The individual number may be a national identification number given to citizens to identify a particular individual. The application information transmission portion 130 sends the acquired facial photograph and individual number of the applicant to the application processing device. The notification portion 140 notifies the applicant of the result of the acceptance of the passport application.

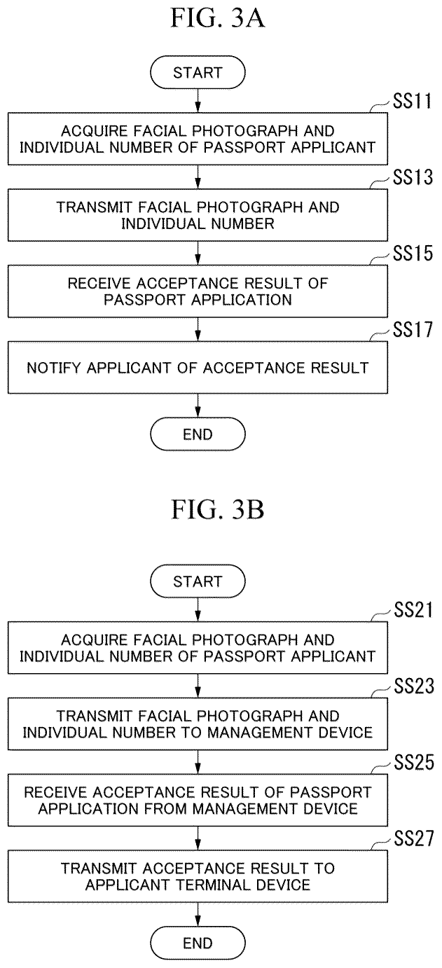

FIGS. 3A and 3B are flowcharts of the process for applying for a passport according to the example embodiment.

As shown in FIG. 3A, the applicant terminal device 100 according to the present example embodiment first acquires the facial photograph and individual number of the passport applicant (SS11). The facial photograph of the applicant is acquired by the acquisition portion 110. The individual number is obtained by the authentication portion 120. Next, the application information transmission portion 130 transmits the facial photograph and individual number acquired in Step S11 to the application processing device (SS13).

In addition to transmitting a facial photograph and individual number in Step S13, the application information transmission portion 130 of the applicant terminal device 100 according to the example embodiment may be configured to further provide a videophone-type communication service with the terminal device 600, thereby providing time for a face-to-face conversation between the person in charge at the passport issuing agency and the applicant. This allows the passport issuing agency's staff to indirectly confirm the applicant's own face and details. More details on this will be provided later.

When the applicant terminal device 100 transmits the facial photograph and individual number in Step S13, the passport application process is carried out by the application processing device 200.

Thereafter, the application information transmission portion 130 receives the acceptance result of the passport application from the application processing device (SS15). When the result of the passport application acceptance is received, the notification portion 140 notifies the passport applicant of the result (SS17). If the applicant's passport application is accepted, the passport will be issued by the passport issuing authority at a later date. If the passport application is rejected, it may be because there are some errors in the application. In this case, the passport applicant takes measures such as applying for a passport again. In this manner, the applicant terminal device 100 functions as a device through which a passport applicant applies for a passport.

### Application Processing Device

Next, the application processing device 200 will be described with reference to FIGS. 2 and 3B.

The application processing device 200 has, for example, an application information acquisition portion 210, a passport application portion 220, and an acceptance result transmission portion 230. The application information acquisition portion 210 acquires the passport applicant's facial photograph and individual number from the applicant terminal device 100. The passport application portion 220 transmits the acquired facial photograph and individual number to the management device 300 and applies for a passport. The acceptance result transmission portion 230 transmits the acceptance result of the passport application by the management device 300 to the applicant terminal device 100.

As shown in FIG. 3B, the application processing device 200 according to the present example embodiment first acquires, via the application information acquisition portion 210, the applicant's facial photograph and individual number for the passport transmitted from the applicant terminal device 100 (SS21). The passport application portion 220 transmits the applicant's facial photograph and individual number to the management device 300 of the passport issuing institution, and submits the passport application (SS23). When a passport application is made in Step S23, identity verification based on the individual number is performed by the management device 300 of the passport issuing institution, whereby a determination is made whether a passport may be issued to the applicant.

Thereafter, the passport application portion 220 receives the acceptance result of the passport application from the management device 300 (SS25). When the acceptance result of the passport application is received, the acceptance result transmission portion 230 transmits the result to the applicant terminal device 100 (SS27). The applicant terminal device 100 which has received the acception result of the passport application notifies the applicant of the result. In this manner, the application processing device 200 submits a passport application to the passport issuing authority on behalf of the passport applicant.

In such an applicant terminal device 100 and application processing device 200, a passport application is made using the individual number of the passport applicant, so that the identity of the applicant can be reliably confirmed in the management device 300. In addition, the applicant's facial photograph for a passport is data captured by the applicant terminal device 100, and the facial photograph is sent directly to the management device 300 via the application processing device 200 without being received by the passport applicant. Therefore, applicants cannot commit fraud such as altering their facial photos or replacing them with a photo of someone else. This allows secure application for a passport online. In addition, by using the applicant terminal device 100, it is possible to apply for a passport using a photograph that has the image quality, background, and other qualities required for a passport photograph.

### Delivery Person Terminal Device 400

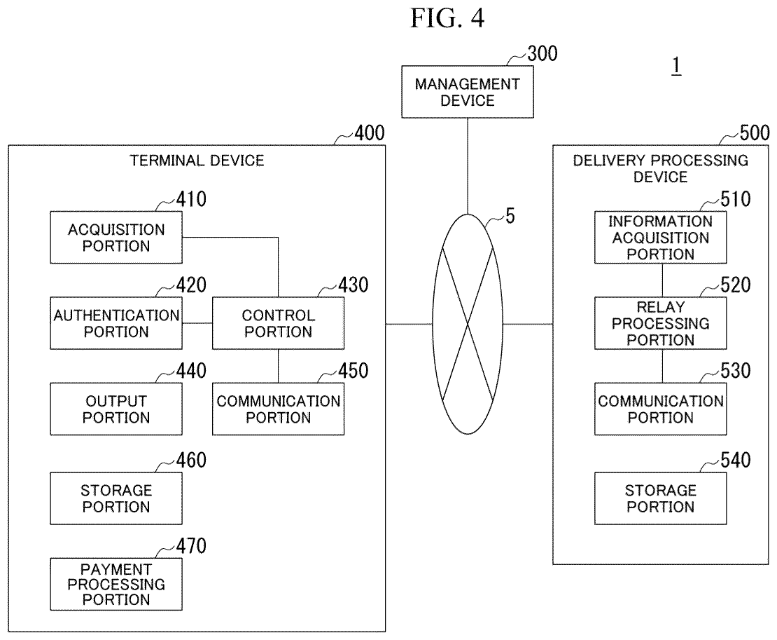

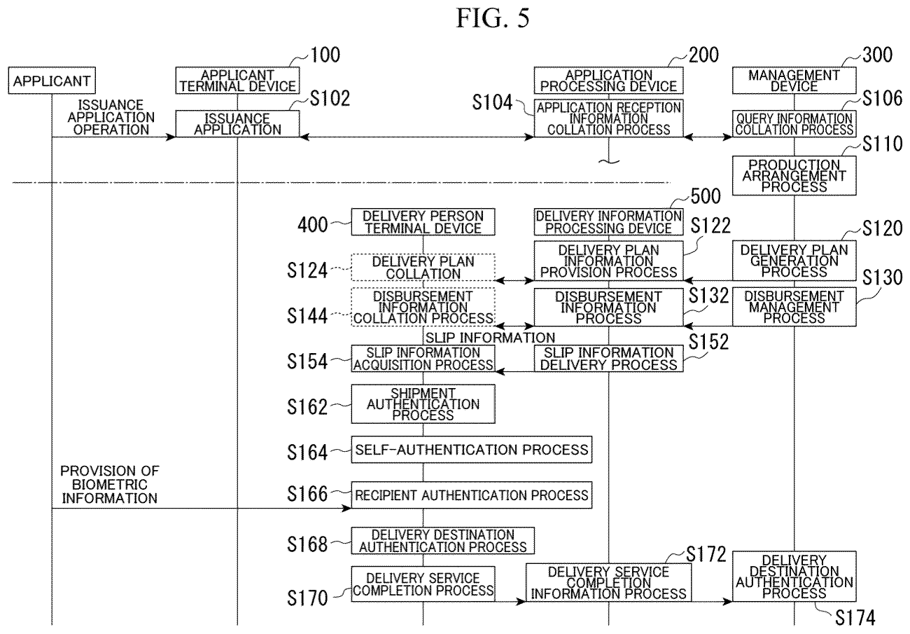

Next, the delivery person terminal device 400 will be described with reference to FIG. 4.

FIG. 4 is a configuration diagram of the delivery person terminal device 400 and the delivery information processing device 500 according to the example embodiment.

The delivery person terminal device 400 includes an acquisition portion 410, an authentication portion 420, a control portion 430, an output portion 440, a communication portion 450, a storage portion 460, and a payment processing portion 470. The payment processing portion 470 will be described later.

The acquisition portion 410 acquires the subject's biometric information and temporarily adds it to the storage portion 460. The term “subject” here includes passport applicants, recipients, delivery personnel, etc. The recipient of the passport may be a recipient (agent) who receives the passport on behalf of the person applying for the passport (the person himself) if necessary. Such a case would apply, for example, when the applicant for a passport is a child (minor) and the recipient is his/her parent (adult).

In this case, for example, the acquisition portion 410 is configured to include a camera, a scanner, a microphone, a reading device, and the like. The camera of the acquisition portion 410 captures images of the vicinity of the delivery person terminal device 400 to acquire image information of people in the vicinity of the delivery person terminal device 400. For example, by using the camera of the acquisition portion 410, it is possible to obtain image information of a quality that allows the facial features of the person to be detected. The scanner of the acquisition portion 410 reads information presented on the surface of a medium such as a document or a card, and collects the text information and image information contained therein. The microphone of the acquisition portion 410 collects sounds around the delivery person terminal device 400. The reading device of the acquisition portion 410 reads information written in a storage medium such as a semiconductor memory and collects this information.

The authentication portion 420 authenticates the subject using the biometric information of the subject acquired by the acquisition portion 410. The authentication portion 420 in the present example embodiment is disposed in the delivery person terminal device 400, which is positioned as a so-called edge computer.

The control portion 430 causes the output portion 440 associated with the delivery person who delivers a passport, such as a passport that holds the biometric information of the subject, to output information relating to the authentication result of the subject. The information regarding the authentication result of the subject may include information indicating whether the authentication was successful or not, and information indicating whether the handover of the passport is permitted or not.

The output portion 440 includes a display portion that displays various images such as the acquired facial image and images showing operation procedures. The display portion may be provided with an operation reception portion that can be used as a touch panel.

The communication portion 450 includes a communication interface that communicates with the delivery information processing device 500 and the management device 300 via a network.

The storage portion 460 is configured by including a semiconductor memory.

The delivery person terminal device 400 may be configured as described above.

The delivery information processing device 500 includes an information acquisition portion 510, a relay processing portion 520, a communication portion 530, and a storage portion 540.

The information acquisition portion 510 acquires information generated by the management device 300, the delivery person terminal device 400, and the like, and temporarily adds the information to the storage portion 540.

The relay processing portion 520 relays information generated by the management device 300 to the delivery person terminal device 400, and also relays information in the opposite direction.

The communication portion 530 includes a communication interface that communicates with the delivery person terminal device 400 and the management device 300 via a network.

The storage portion 460 is configured by including a semiconductor memory, a magnetic recording device, and the like.

The delivery information processing device 500 may be configured as described above.

### Specific Examples of Biometric Information About a Subject

The subject's biometric information in the above-mentioned manner may include either image information or acoustic information that enables individual identification of the subject. Image information that enables individual identification of a subject is image information such as the subject's face, iris, fingerprints, palm print, and veins. Acoustic information that enables individual identification of a subject is information based on the subject's voice, ear acoustics, and other acoustics. Ear acoustic authentication is an authentication method based on individual differences in the spatial structure of the head, including the ear canal (external auditory canal). For example, an earphone-type authentication device is used to send a test sound toward the ear canal (external auditory canal), and individuality is measured from differences in the frequency components of the reflected sound, making it possible to identify individuals based on this.

In the following description, facial information (facial photo) will be used as an example of biometric information, but the present disclosure is not limited to this and any of the above-mentioned biometric information may be used as appropriate. For example, multimodal authentication is also possible, in which multiple pieces of the above biometric information are appropriately used. By performing authentication processing using biometric information such as image information or acoustic information that enables individual identification of the subject, the accuracy of the target authentication processing can be increased and false receipts through impersonation or the like can be prevented.

The flow from application to delivery in this example embodiment will be described with reference to FIG. 5.

FIG. 5 is a diagram for explaining the delivery process according to the example embodiment.

An applicant applies for a passport by using a communication service over a network and using the applicant's individual number. For example, the applicant operates the applicant terminal device 100 to send a request to start the application procedure to the application processing device 200.

The applicant terminal device 100 is provided with an information screen for application procedures by the application processing device 200. The applicant terminal device 100 displays the information screen for the application procedure. The applicant uses the applicant terminal device 100 to enter the information requested by the information screen for the application procedure. The applicant terminal device 100 acquires facial image information (biometric information) of the applicant and sends it to the application processing device 200 (S102).

The application processing device 200 acquires information for the application procedure and the applicant's facial image information provided by the applicant terminal device 100, associates them with the applicant's identification information, and notifies the management device 300 of the information for the application procedure including the applicant's identification information and facial image information for causing it to perform collation (S104).

The management device 300 uses the information for the application procedure in accordance with predetermined rules to perform the authentication process of the applicant and the acceptance process of the application (S106). It is assumed that delivery was specified as the method of receiving the passport at the time of application, and that the application from this applicant has been approved safely. Depending on the delivery method specified by the applicant, the issued passport can be collected at the passport issuing institution's counter or delivered.

The management device 300 generates a delivery plan for the passport (S120) and notifies the delivery information processing device 500 of information related thereto.

When the delivery information processing device 500 is provided with information relating to the passport delivery plan from the management device 300, the delivery information processing device 500 may provide information relating to the passport delivery operation to the delivery person terminal device 400 (S122). For example, the delivery information processing device 500 accepts a request from the deliveryman terminal device 400 to view information related to the delivery of a passport and to provide information (delivery plan collation: S124). In response to a request from the delivery person terminal device 400, the delivery information processing device 500 transmits to the delivery person terminal device 400 information on a delivery plan related to the delivery of the passport. This allows the delivery person to obtain information about the delivery plan.

Next, the management device 300 executes the process of managing the issuance of the passport to be delivered (S130), and notifies the delivery information processing device 500 of information related thereto.

When the delivery information processing device 500 is provided with information regarding the issuance of the passport to be delivered from the management device 300, the delivery information processing device 500 may provide the information regarding the issuance of the passport to be delivered to the delivery person terminal device 400 (S132). For example, the delivery information processing device 500 receives a request from the delivery person terminal device 400 to view information regarding the issuance of a passport to be delivered and to provide the information (issuance information inquiry: S134) is accepted. In response to a request from the delivery person terminal device 400, the delivery information processing device 500 transmits information regarding the issuance of the passport to be delivered to the delivery person terminal device 400. This allows the delivery person to obtain information regarding the issuance of the passport to be delivered.

For example, the delivery of passports is entrusted to a delivery company that undertakes delivery operations. The delivery company will then use a delivery person to deliver the passport to a specific address designated by the delivery service contracted. This allows applicants to collect their passports at the location where they previously applied.

By appropriately operating the delivery person terminal device 400, the delivery person can view information related to the passport delivery schedule, information related to the issuance of the passport to be delivered, and the like. These operations can be performed at any time.

In this way, the delivery information processing device 500 can return information to the delivery person terminal device 400 in response to a request from the delivery person terminal device 400 by communicating with both the delivery person terminal device 400 and the management device 300.

For example, the delivery information processing device 500 provides the delivery person terminal device 400 with delivery slip information including delivery destination information of the passport assigned to the delivery person. The delivery person terminal device 400 receives the slip information and displays the slip information on the display portion in response to an operation by the delivery person. The delivery person confirms the slip information and travels to the specified delivery destination. When the delivery person reaches the designated delivery destination, if the results of several authentication processes are satisfactory, the delivery person hands over the passport to the applicant.

The above authentication process may include, for example, the following processes.
Verification that the passport to be delivered has been correctly selected (shipment authentication process, S162).
Verification that the delivery person is the scheduled delivery person himself (self-authentication process, S164).
Verification that the recipient is the applicant himself (recipient authentication process, S166).
Verification of the validity of the delivery destination (delivery destination authentication process, S168).

Specific examples of these processes will be described later.

The delivery person finishes his/her work for that delivery destination for the day, in both cases where the delivery is completed successfully and not for some reason. The delivery person terminal device 400 notifies the delivery information processing device 500 of the completion of the delivery operation (S170).

The delivery information processing device 500 collects information on whether or not the delivery of the passport has been completed without any problems based on a notification from the delivery person terminal device 400.

The delivery information processing device 500 provides the management device 300 with a delivery completion report summarizing the collected information on whether or not the delivery of the passport has been completed without any problems (S172).

The management device 300 can thereby obtain information as to whether or not the delivery of the passport has been completed without any problems (S174).

Each of the above authentication processes will now be described in turn with more specific examples.

### Verify That Passport to be Delivered is Correctly Selected: Delivery Authentication Process

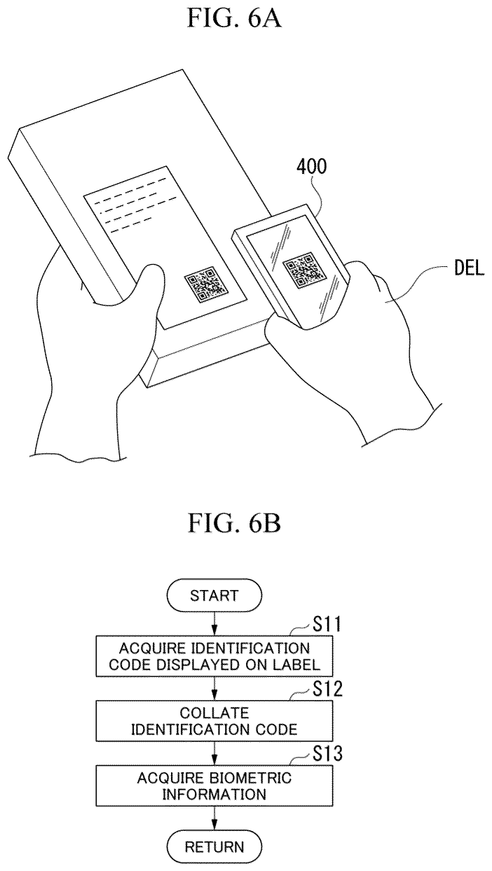

FIG. 6A is a diagram for explaining the delivery authentication process according to the example embodiment. FIG. 6B is a flowchart of the delivery authentication process according to the example embodiment.

The situation shown in FIG. 6 is one in which a delivery person is, checking whether the passport to be delivered has been correctly selected, by using the delivery person terminal device 400.

When a passport is being delivered, a label with an identification code, address, etc. printed on it is attached to the packaging.

The delivery person uses the delivery person terminal device 400 to capture an image of the label attached to the package and obtain the identification code. At that time, the delivery person points the optical axis of the camera of the delivery person terminal device 400 toward the label surface, and further adjusts the direction of the optical axis and the distance to the label while viewing the through image displayed on the display portion of the delivery person terminal device 400 so that the identification code falls within a specified imaging range. The details of the method for identifying this identification code and obtaining information about the identification code may be any known method.

The acquisition portion 410 of the delivery person terminal device 400 acquires the identification code attached to the packaging of the passport during delivery, and collates the slip number indicated by the identification code with the slip number indicating the delivery operation that has been designated in advance by the management device 300. If the collation result is successful, it may be determined that the passport destined for delivery from the shipment has been correctly selected. If this collation is not successful, a passport other than that of the specified delivery service may have been selected.

After successfully collating the slip number indicated by this identification code, the acquisition portion 410 acquires the biometric information of the subject corresponding to the identification code (S11).

The authentication portion 420 uses the subject's biometric information to authenticate whether the recipient of the passport is the passport applicant or not (S12). The authentication portion 420 may cause the output portion 440 to output the result of the authentication that the recipient of the passport is the applicant (S13).

This makes it possible to utilize various information contained in the identification code. This various information may include personal information of the applicant, as well as image information corresponding to the applicant's biometric information, feature information that quantifies the biometric information, and other data. For example, if the identification code contains features, authentication can be performed using the features and the features of the applicant's facial image. By using this identification code, the information used for authentication is available without opening the shipping package.

### Verifying That Delivery Person is Intended Delivery Person Himself: Self-Authentication Process

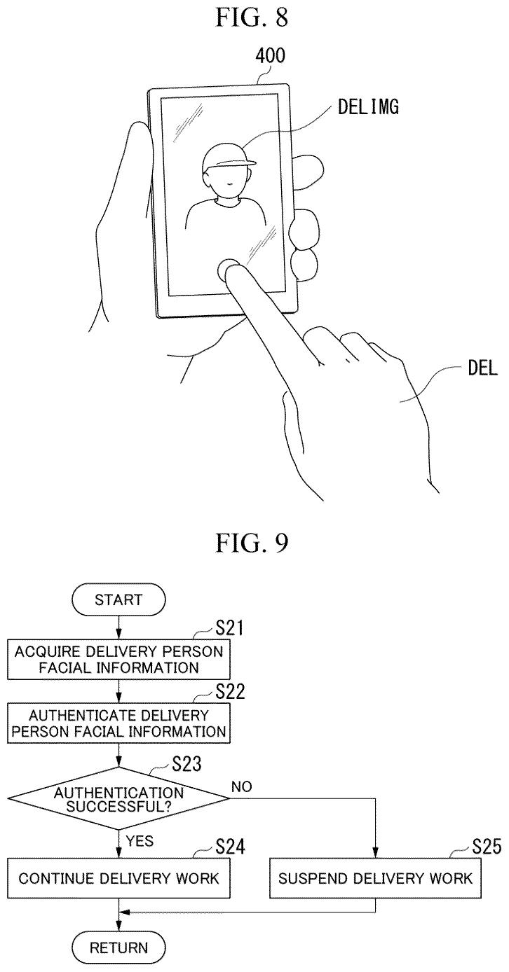

The authentication process (self-authentication process) for the delivery person according to the example embodiment will be described with reference to FIGS. 8 and 9. FIG. 8 is a diagram for explaining authentication processing (self-authentication processing) for a delivery person according to the example embodiment. FIG. 9 is a flowchart of authentication processing (self-authentication processing) for a delivery person according to the example embodiment. The display portion of the terminal device 400 shown in FIG. 8 displays biometric information (image DELIMG) of the delivery person.

The biometric information to be identified to which the delivery person terminal device 400 is appliable includes the face information of the delivery person (fourth biometric information, image DELIMG).

The authentication portion 420 performs authentication processing on the delivery person using facial information (fourth biometric information) of the delivery person.

In addition, if the authentication of the delivery person is successful, it is preferable to carry out authentication processing using the biometric information of the applicant (subject).

This will be explained in more detail below.

First, the delivery person is photographed by the camera of the acquisition portion 410, and the facial information and individual identification number of the passport delivery person are acquired (S21). The authentication portion 420 collates the facial information (facial photo) and individual identification number of the delivery person acquired in Step S21 using the facial information and individual identification number of the delivery person previously registered in the storage portion 460, and performs authentication processing of the facial information of the delivery person (S22). If the authentication is successful in Step S23, the authentication portion 420 allows the delivery person to continue the delivery work (S23), and ends the series of processes. If the authentication fails in Step S23, the authentication portion 420 suspends the delivery work of the delivery person (S24) and ends the series of processes.

This makes it possible to verify before the work begins that there are no inconsistencies in the combination of the delivery person terminal device 400 used during delivery work and the delivery person who will use it. This is expected to have effects such as disabling the functions of the delivery person terminal device 400 if the delivery person terminal device 400 is stolen, and preventing people other than the corresponding delivery person from using the delivery person terminal device 400 by impersonating a delivery person. In addition, by identifying the person who delivered the passport (delivery), if any problems arise later with the delivery of the passport, it will be possible to immediately identify the deliverer and take action to resolve the issue.

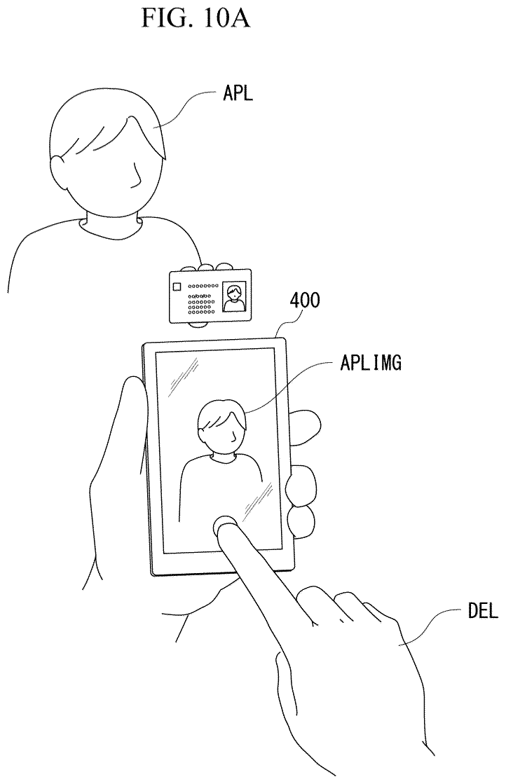

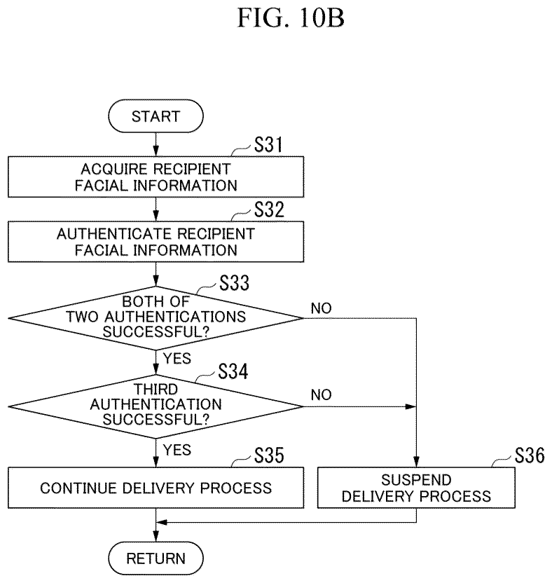

The applicant authentication process of the example embodiment will be described with reference to FIGS. 10A and 10B.

### Type of Applicant's Biometric Information Used for Applicant Authentication Processing

FIG. 10A is a diagram for explaining the use of a certificate including biometric information of the applicant APL according to the example embodiment. The display portion of the terminal device 400 shown in FIG. 10A displays first biometric information (image APLIMG) about a potential recipient of the certificate.

Biometric information about a subject includes first biometric information (image APLIMG) about a subject who may be a recipient of the passport, second biometric information about the subject obtained from a certificate other than a passport, and third biometric information about the subject obtained from the passport or an identification code associated with the passport.

The authentication portion 420 authenticates the subject using, for example, the first biometric information about the subject, the second biometric information about the subject, and the third biometric information about the subject as the biometric information about the subject.

This allows the subject's biometric information to be obtained from three different sources and used for authentication, thereby increasing the flexibility of the method for determining whether delivery should be permitted in the authentication process. This determination method will be described in detail later.

### Example of Applicant Authentication Process: Part 1

Referring to FIG. 10B, the applicant authentication process (part 1) of the example embodiment will be described.

FIG. 10B is a flowchart of the applicant authentication process (part 1) according to an example embodiment. The applicant authentication process (part 2) will be described later. Applicants themselves must collect their passports in person. Verify that the recipient is the applicant himself.

First, the acquisition portion 410 acquires three types of facial information of the passport recipient using the individual identification number as a key (S31). The authentication portion 420 performs authentication processing using the three types of facial information of the recipient (S32). It is determined whether or not the first and second authentications of the first set and the second set described below have been successful (S33). If either of the first set and second set of authentications described below fails in Step S33, authentication portion 420 advances the process to Step S36. In Step S33, if the two authentications of the first set and second set described below are successful, the authentication portion 420, if the three authentications of the first, second, and third sets described below are successful, allows the delivery person to continue his/her delivery work (S35), and ends the series of processes. If the determination is negative in both steps S33 and S35, the authentication portion 420 suspends the delivery work of the delivery person (S36) and ends the series of processes.

In a more specific example of the recipient (subject) authentication process, the authentication portion 420 separates the three types of biometric information into the following three sets and performs authentication for each set.

For example, the authentication portion 420 performs the following first to third sets of authentication.

The authentication portion 420 authenticates the subject using the first biometric information about the subject and the second biometric information about the subject as the first set of authentication.

The authentication portion 420 authenticates the subject using the first biometric information about the subject and the third biometric information about the subject as the second set of authentication.

The authentication portion 420 authenticates the subject using the second biometric information about the subject and the third biometric information about the subject as the third set of authentication.

In this way, the authentication portion 420 performs authentication using the three types of biometric information, dividing them into the above three sets.

This makes it possible to verify that the recipient is the applicant himself.

In a more specific example of the recipient authentication process applied at this time, priority is given to an authentication process using the first biometric information about the recipient (subject). For example, the authentication process of “part 1” above is given priority. Even if the result of authentication using the first biometric information about the subject is unsuccessful, for example, the authentication portion 420 may further attempt to authenticate the recipient (subject) using a third set that combines the subject's second biometric information and the subject's third biometric information when authentication of the target using the first biometric information about the subject is not working properly.

This makes it possible to avoid circumstances in which the features of the acquired first biometric information about the subject are difficult to use for authentication processing due to some factor.

### Verifying Validity of Delivery Address: Delivery Destination Authentication Process

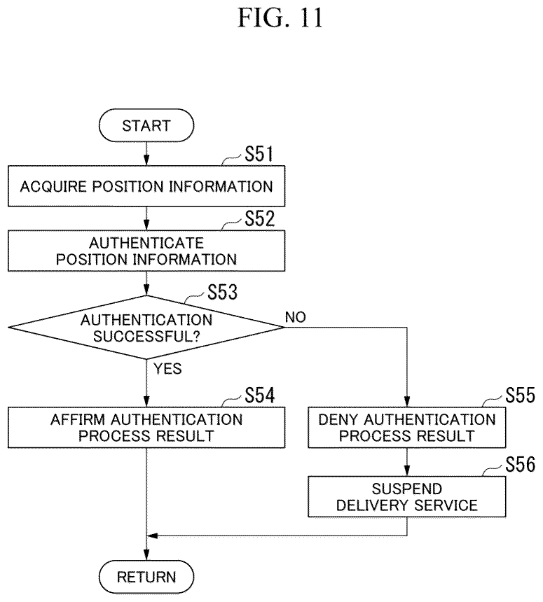

The delivery destination authentication process according to the example embodiment will be described with reference to FIG. 11.

FIG. 11 is a flowchart of the delivery destination authentication process according to the example embodiment.

The authentication portion 420 may affirm the authentication result of the delivery person if the first location where issuance of a passport was applied for and the second location where the first biometric information of the recipient was generated by photographing the recipient during the delivery stage are within a predetermined distance range. In this case, the authentication portion 420 may similary use it for verifying the validity of the delivery person's authentication result.

The above-mentioned “first location where issuance of a certificate was applied for” may be, for example, either of the following:
The location the applicant has applied for as the pick-up location
The location of the device used by the applicant when applying online

The aforementioned terminal may be the applicant terminal device 100 or may be something different from the applicant terminal device 100. The terminal may obtain the location of the terminal during the online application from GPS (GNSS) or the like, or may obtain the location based on network information.

The authentication portion 420 may include in the information on the authentication result of the subject either information indicating whether the authentication was successful or information indicating whether the transfer of the certificate is permitted.

This makes it possible to verify the validity of the delivery destination using the location information of the delivery destination.

According to the above example embodiment, the information processing system 1 includes an acquisition portion 410 that acquires biometric information about a subject, an authentication portion 420 that authenticates the subject using the acquired biometric information of the subject, and a control portion 430 that causes an output portion 440 that is associated with the delivery person who delivers a certificate possessing the biometric information about the subject to output information regarding the authentication result of the subject, thereby making it possible to reduce risks from a security perspective and make it possible to receive certificates such as passports at places other than the counter of a designated institution. As a result, this reduces the cases where the applicant will visit the counter of a designated institution, and it will increase convenicence for the applicant to obtain a certificate.

### Second Example Embodiment

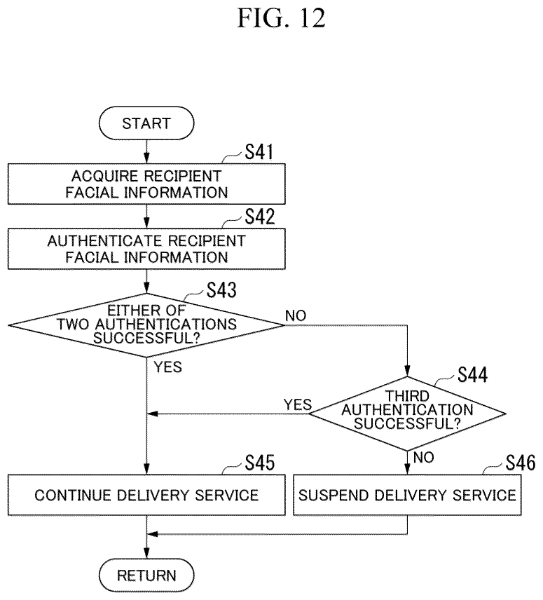

The second example embodiment will be described with reference to FIG. 12.

In the above-described first example embodiment, an example of a determination method for determining facial authentication more strictly was shown. In contrast, in this example embodiment, a determination method that can increase the accuracy of facial authentication and reduce authentication failures will be described.

### Specific Example of Applicant Authentication Process No. 2

FIG. 12 is a flowchart of the applicant authentication process (No. 2) according to the example embodiment.

First, the acquisition portion 410 acquires three types of facial information of the passport recipient using the individual identification number as a key (S41). The authentication portion 420 performs authentication processing using three types of face information of the recipient (S42). It is determined whether authentication of either the first or second set described below has been successful (S43). In Step S43, if either of the first and second sets of authentications described below fails, the authentication portion 420 determines whether the third authentication set has succeeded (S44).

If the determination in Step S43 is affirmative, or if the determination in Step S44 is affirmative, the delivery person is allowed to continue the delivery work (S45), and the series of processes is terminated. If the determination is negative in both steps S43 and S44, the authentication portion 420 suspends the delivery work of the delivery person (S46), and ends the series of processes.

According to the above procedure, when there are circumstances that make the accuracy of facial authentication relatively low, it is possible to increase the accuracy of facial authentication and reduce authentication failures.

### Third Example Embodiment

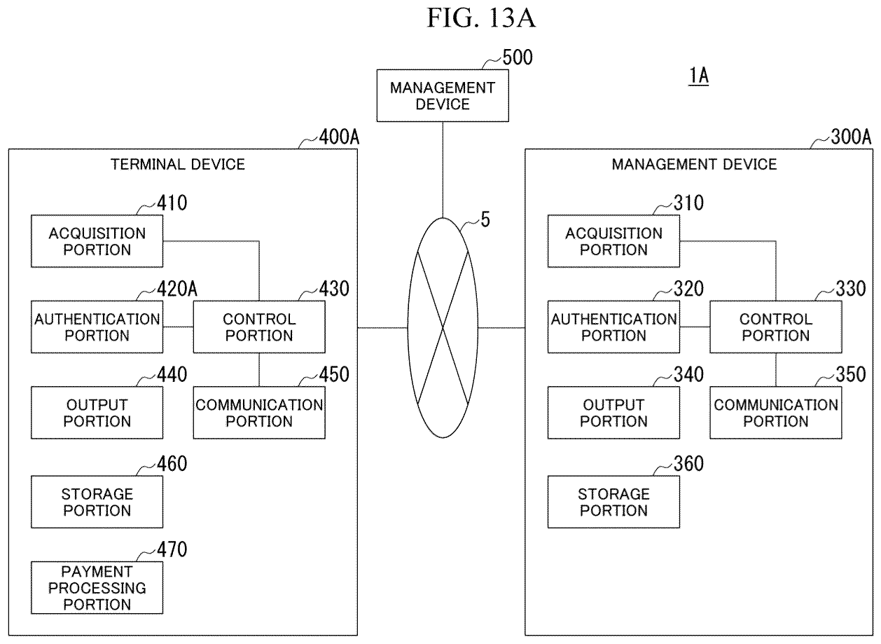

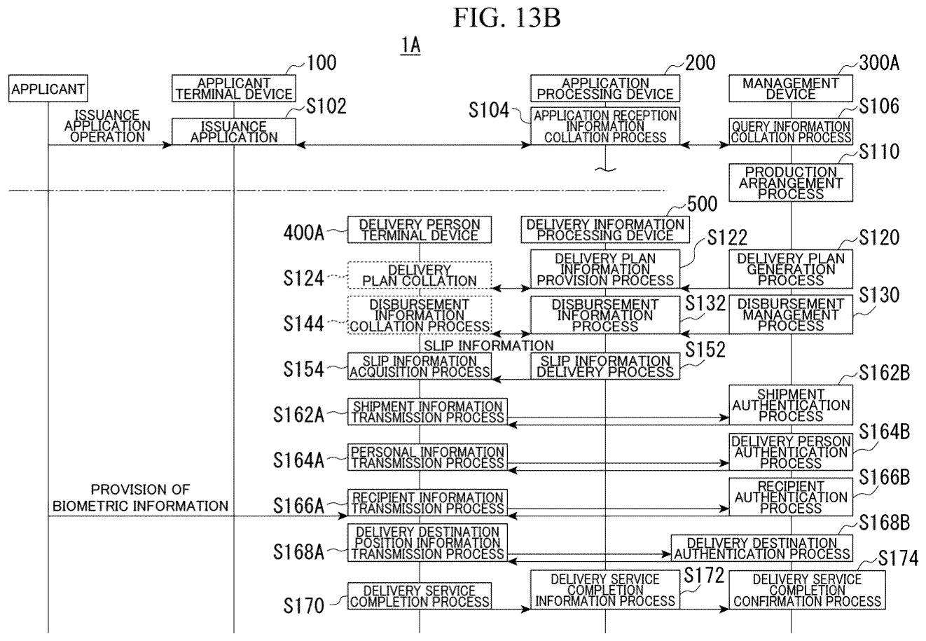

A third example embodiment will be described with reference to FIGS. 13A and 13B.

In the above-described first example embodiment, a case was described in which the authentication process is performed by the delivery person terminal device 400 positioned as an edge computer. Instead, a case will be described in which the authentication process is performed by a computer positioned as a cloud computer.

FIG. 13A is a configuration diagram of a delivery person terminal device 400A and a management device 300A according to the third example embodiment. FIG. 13B is a diagram for explaining the delivery process according to the third example embodiment.

The main difference with the delivery person terminal device 400 and the management device 300 shown in FIG. 5 described above is that the entity that executes the authentication process is changed from the delivery person terminal device 400 to the management device 300A. The following describes the changes that have been made as a result of this change.

The authentication processing portion 420A of the delivery person terminal device 400A does not perform authentication processing as performed by the delivery person terminal device 400, but relays information collected for authentication processing to the management device 300A.

Specifically, the authentication processing portion 420A of the delivery person terminal device 400A transmits the information collected for the delivery authentication process to the management device 300A (S162A), and causes the management device 300A to carry out the delivery authentication process (S162B). The authentication processing portion 420A of the delivery person terminal device 400A obtains the result of the delivery item authentication processing from the management device 300A.

In addition, the authentication processing portion 420A of the delivery person terminal device 400A transmits the information collected for the delivery person's self-authentication processing (e.g., the delivery person's facial information, etc.) to the management device 300A (S164A), and causes the delivery person authentication processing to be carried out in the management device 300A (S164B). The authentication processing portion 420A of the delivery person terminal device 400A obtains the result of the delivery person authentication processing from the management device 300A.

In addition, the authentication processing portion 420A of the delivery person terminal device 400A transmits the information collected for the recipient authentication processing (e.g., the recipient's facial information, etc.) to the management device 300A (S166A), and causes the management device 300A to carry out the recipient authentication processing (S166B). The authentication processing portion 420A of the delivery person terminal device 400A obtains the result of the recipient authentication processing from the management device 300A.

In addition, the authentication processing portion 420A of the delivery person terminal device 400A transmits the information collected for the authentication processing of the delivery destination (e.g., location information of the delivery person terminal device 400A) to the management device 300A (S168A), and causes the management device 300A to carry out the authentication processing of the delivery destination (S168B). The authentication processing portion 420A of the delivery person terminal device 400A obtains the result of the authentication processing of the delivery destination from the management device 300A.

As described above, the delivery person terminal device 400A collects information for various authentication processes, but the authentication processes themselves are carried out in the management device 300A.

According to this, the calculation load on the delivery person terminal device 400A is smaller than that on the delivery person terminal device 400. Accordingly, the power consumption by the delivery person terminal device 400A becomes less than the power consumption by the delivery person terminal device 400. As a result, the continuous operating time of the delivery person terminal device 400A from a fully charged state is generally longer than the continuous operating time of the delivery person terminal device 400 from a fully charged state when compared with a battery of the same capacity. In this comparison, the influence of individual differences such as part deterioration is not taken into account.

Note that instead of being located at the passport issuing institution, this management device 300A may be configured in a computer system connected to a public network such as the Internet. In this case, the management device 300A can be said to be configured by, for example, a so-called cloud computer.

In this manner, it can be seen that the authentication portion in the information processing system 1A may be disposed in a computer in the cloud or in an edge computer.

### Fourth Example Embodiment

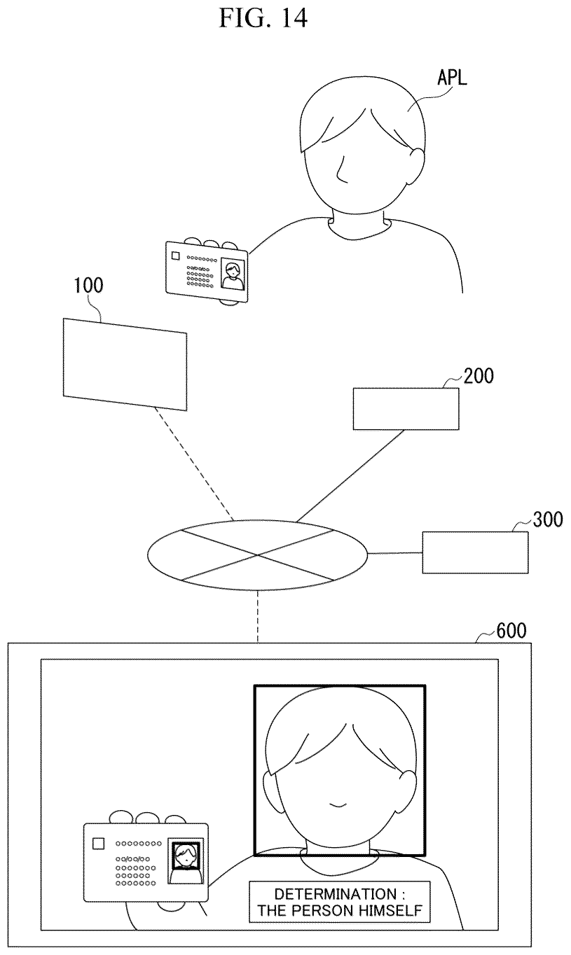

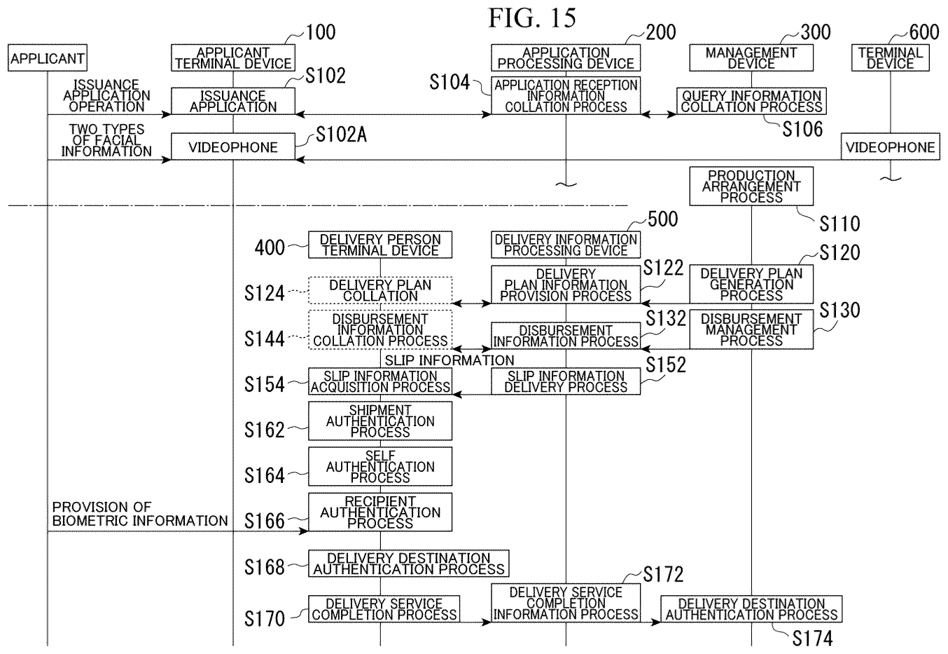

A fourth example embodiment will be described with reference to FIG. 7B, FIG. 14 and FIG. 15.

In the above-described first example embodiment, a case has been described in which a passport application is processed online. According to this “online procedure,” communication services between the applicant terminal device 100, the application processing device 200, and the management device 300 are used.

In addition, in this example embodiment, a videophone service is used between the applicant terminal device 100 and the terminal device 600 to enable staff at the passport issuing agency to indirectly check the applicant's appearance.

FIG. 14 is a diagram for explaining the authentication process of an applicant according to the example embodiment. FIG. 15 is a diagram for explaining the application process according to the example embodiment.

According to the processing by the information processing system 1 described in FIG. 15, when applying for a passport, an applicant terminal device 100 (first terminal) used by the applicant and a terminal device 600 (second terminal) of the passport issuing agency (related agency) are connected so as to be able to communicate with each other using a videophone service. The acquisition portion 110 of the applicant terminal device 100 (first terminal) acquires a facial image of the applicant and the facial image on the driver's license (FIG. 7B) presented by the applicant, and sends them to the terminal device 600 (second terminal) of the passport issuing agency (related agency) using a videophone service. The terminal device 600 (second terminal) of the passport issuing institution (associated institution) acquires from the applicant terminal device 100 the facial image of the applicant and, for example, the facial image on the driver's license acquired by the applicant terminal device 100. The authentication portion 120 of the applicant terminal device 100 may collate the facial image of the applicant with the facial image on the driver's license, and send the result of the collation to the terminal device 600 (second terminal) for output. FIG. 14 shows an example of the display on the display screen of the terminal device 600 (second terminal).

For example, as shown in FIG. 14, the applicant APL holds his/her driver's license in his/her right hand, with the side on which his/her photograph is printed facing the applicant terminal device 100. In this state, the acquisition portion 110 (camera) of the applicant terminal device 100 can capture the face of the applicant APL and his/her right hand holding the driver's license within a common image. The applicant terminal device 100 sends the captured image including the face of the applicant APL and the right hand holding the driver's license to the terminal device 600 (second terminal). As a result, the image sent from the applicant terminal device 100 is displayed on the display portion of the terminal device 600 (second terminal) if communication is possible.

On the other hand, the applicant terminal device 100 may be further configured as follows.

The application information transmission portion 130 of the applicant terminal device 100 performs compression processing of the image information when sending the applicant's facial image acquired by the applicant terminal device 100 and, for example, the facial image on the driver's license to the terminal device 600 (second terminal). Depending on the compression method, techniques are used such as identifying and extracting parts of an image to achieve efficient compression.

Therefore, in the present example embodiment, if the feature amounts of image areas extracted by this extraction process are similar within a specified range and are contained within a common screen, it can be determined that there is a high probability that the image of the applicant's own face and the image of the face portion in the image on the applicant's license form a pair. In this case, the size of the image of the applicant's face and the size of the image of the face portion in the image on the applicant's license are different, so size consistency is not required. Rather, it would be better to use the similarity in the ratio between facial feature points showing facial appereance as a key to make the determination.

The display portion of the terminal device 600 shown in FIG. 14 displays marker displays to indicate the positions extracted as the applicant's own face and as the facial portion of the image in the applicant's license with being superimposed on the original image. In this example image, two rectangles of different sizes (area) are positioned to match the positions of the respective faces. This rectangle moves along with the face if its position in the image moves.

Furthermore, since the facial features present within the above two rectangles have been found to be higher than a predetermined criterion, the words “the person himself/herself” indicating that they are the same person is displayed as a result of the comparison. If the result is lower than a predetermined criterion, a message such as “different person” is displayed as the result of the comparison.

In this way, the applicant terminal device 100 does not simply transmit the collected images, but when a facial image with highly similar feature amounts is detected, it can determine the similarity of the features and send the determination result to the terminal device 600.

### Modifications

The information processing system 1 may include an application reception processing portion that receives an application for issuance of the certificate from an applicant. This application reception processing portion performs authentication processing using the applicant's biometric information and the subject's third biometric information, thereby enabling authentication of the applicant at the application processing stage to be performed based on the biometric information contained in a certificate other than a passport.

### Fifth Example Embodiment

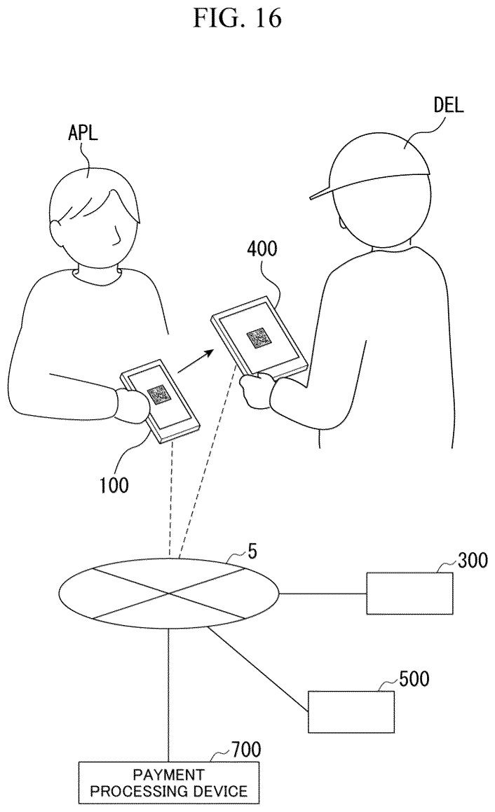

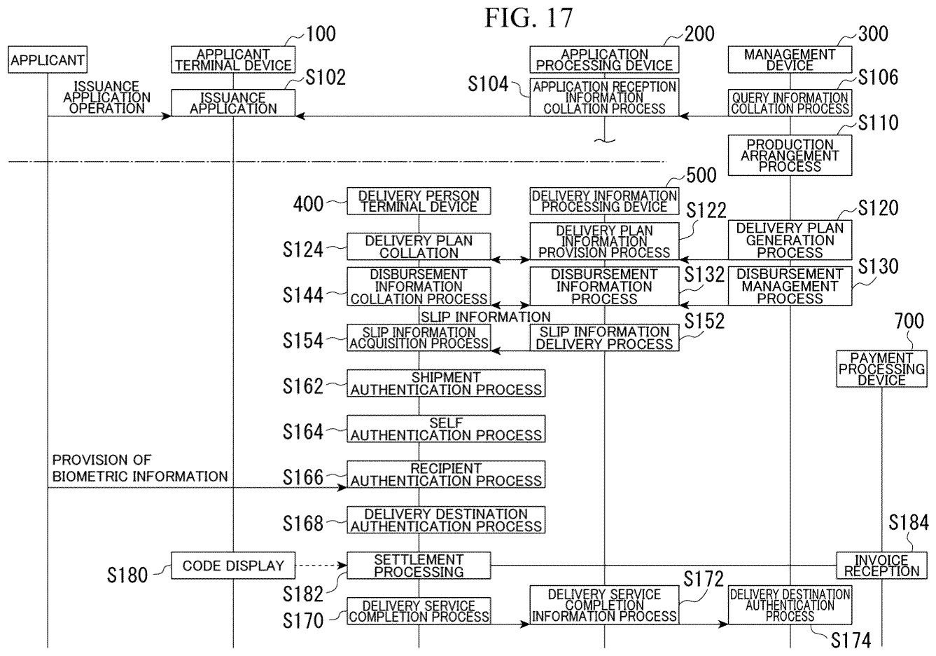

In the fifth example embodiment, the payment process for the passport issuance and delivery process will be described with reference to FIGS. 16 and 17.

In the case of the application procedure at the counter of a government agency in the comparative example, money can be handed over. Unlike the case of using at a counter, when applying online, it is not easy to give or receive money.

In this example embodiment, therefore, a case will be described in which the costs of issuance and delivery processing can be paid by credit card at the time of delivery of the passport.

FIGS. 16 and 17 are diagrams for explaining the payment process according to the example embodiment.

When the validity of delivering the passport to the recipient (subject) is confirmed by the above authentication, the payment processing portion 470 (cost processing portion) in the information processing system notifies the payment processing device of the financial institution (credit company) of a request for settlement processing of the cost of the issuance and delivery processing.

For example, if the recipient is able to accept the delivered passport and is willing to pay the fee using the payment processing executed by the delivery person terminal device 400, the recipient can make a credit payment in a simple manner using the delivery person terminal device 400.

The recipient causes the applicant terminal device 100 to generate a two-dimensional code in which customer information of the credit company he/she is contracted with, as well as information such as the payment amount and payment terms are intergrated, and display this on the display portion.

The delivery person uses the delivery person terminal device 400 to read the two-dimensional code that has been caused to be displayed on the display portion of the applicant terminal device 100 by the recipient. The delivery person terminal device 400 switches the communication destination to the connection destination indicated by the read two-dimensional code. For example, this connection destination is the payment processing device 700 of a credit company. The payment processing portion 470 of the delivery person terminal device 400 sends the information indicated by the two-dimensional code displayed on the display portion of the applicant terminal device 100 to the payment processing device 700, to thereby cause the payment process to be executed. The payment processing device 700 performs billing processing based on the information provided by the delivery person terminal device 400. The processing of the payment processing device 700 may be carried out using a conventional technique.

According to the example embodiment, the delivery person terminal device 400 can notify the payment processing device 700 of the information necessary for credit payment, eliminating the need for the applicant to visit a financial institution or to set up a separate communication connection for payment processing and complete the procedure. By making a credit payment using the delivery person terminal device 400, the balance of the applicant's savings account can be reduced.

### Sixth Example Embodiment

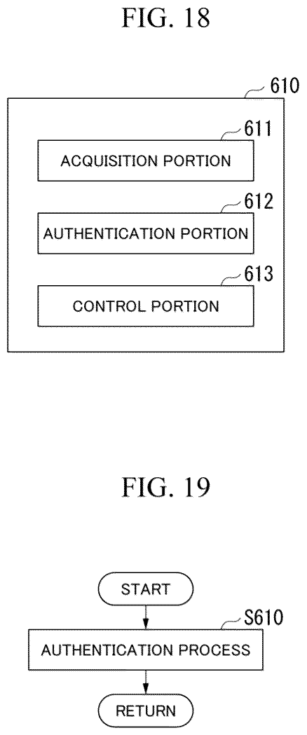

As a sixth example embodiment, a more simply configured aspect will be described with reference to FIGS. 18 to 20.

FIG. 18 is a diagram illustrating an example of the configuration of an information processing system according to the example embodiment. In the configuration shown in FIG. 18, an information processing system 610 includes an acquisition portion 611, an authentication portion 612, and a control portion 613.

In this configuration, the acquisition portion 611 acquires biometric information about a subject. The authentication portion 612 authenticates the subject using the acquired biometric information of the subject. The control portion 613 is configured to output information regarding the authentication result of the subject to a delivery person who delivers a certificate possessing the biometric information about the subject.

FIG. 19 is a flowchart illustrating an example of a processing procedure of an information processing method according to the example embodiment. The information processing method shown in FIG. 19 includes a process (Step S610) of acquiring biometric information of a subject at the delivery stage, authenticating the subject using the acquired biometric information of the subject, and outputting information regarding the authentication result of the subject to a delivery person who delivers a certificate possessing the biometric information about the subject. This allows optimization of information processing systems that are required to improve convenience for certificate applicants.

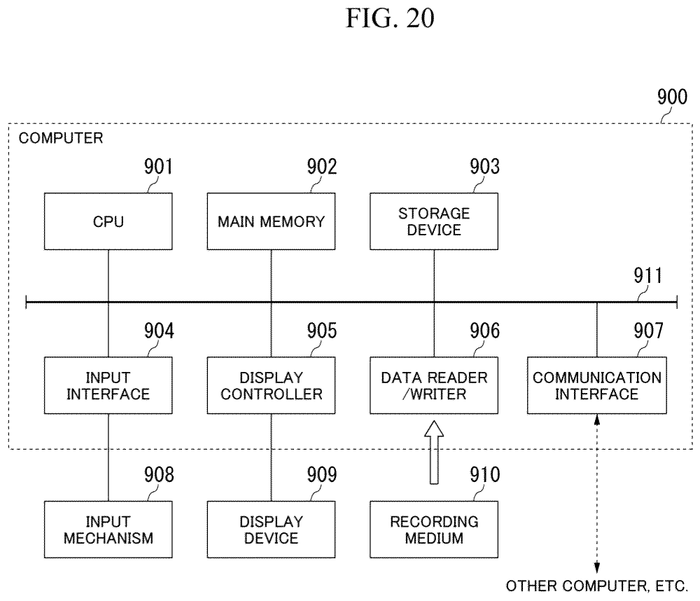

FIG. 20 is a schematic block diagram illustrating a configuration of a computer according to at least one example embodiment.

In the configuration shown in FIG. 20, a computer 900 includes a CPU 901, a main storage device (main memory) 902, a storage device 903, an input interface 904, a display controller 905, a data reader/writer 906, and a communication interface 907.

Any one or more of the delivery person terminal device 400, the management device 300A, and the information processing system 1 described above, or a part thereof, may be implemented in the computer 900. In this case, the operations of the above-mentioned processing units are stored in the storage device 903 in the form of a program. The CPU 901 reads the program from the storage device 903, loads it into the main storage device 902, and executes the above-mentioned processing in accordance with the program. Furthermore, the CPU 901 reserves storage areas in the main storage device 902 corresponding to the above-mentioned storage portions in accordance with the program. The communication between each device and other devices is performed by the communication interface 907 having a communication function and performing communication under the control of the CPU 901.

When the delivery person terminal device 400 or the management device 300A is implemented in the computer 900, the operation of each part thereof is stored in the storage device 903 in the form of a program. The CPU 901 reads the program from the storage device 903, loads it into the main storage device 902, and executes the above-mentioned processing in accordance with the program.

Furthermore, the CPU 901 reserves a storage area in the main storage device 902 for processing by an arithmetic processing device 10 in accordance with the program. Communications between the arithmetic processing device 10 and other devices are performed by the input interface 904 having a communication function and operating under the control of the CPU 901. Interaction between the arithmetic processing device 10 and a user is performed by the input interface 904 having an input device, the display controller 905 having a display device, displaying various images under the control of the CPU 901, and accepting user operations.

In addition, a program for executing all or part of the processing performed by the delivery person terminal device 400 or the management device 300A may be recorded on a computer-readable recording medium 910, and the program recorded on this recording medium 910 may be read into a computer system and executed to perform processing of each part. It should be noted that the term “computer system” herein includes an OS and hardware such as peripheral devices. In this case, it is preferable to obtain data from the recording medium 910 using the data reader/writer 906.

In addition, the term “computer-readable recording medium” refers to portable media such as flexible disks, optical magnetic disks, ROMs (Read Only Memory), and CD-ROMs (Compact Disc Read Only Memory), as well as storage devices such as hard disks built into computer systems. Furthermore, the above program may be for realizing part of the functions described above, and may further be capable of realizing the functions described above in combination with a program already recorded in the computer system.

Although example embodiments of the present invention have been described in detail above with reference to the drawings, the specific configuration is not limited to these example embodiments, and designs that do not deviate from the gist of the present invention are also included.

For example, among the configurations shown in this figure, the management device 300 and the delivery information processing device 500 may be integrated into one device.

Instead of the passport exemplified in the above description, it may be applied to an ID card such as the following.

FIG. 7A is a plan view showing an example of a first ID card C1. The first ID card C1 is, for example, a individual number card (My Number Card). It should be noted that the first ID card C1 is not limited to this, and may be other ID cards such as a driver's license, an employee ID card, an insurance card, a passport, a bankbook, or a seal registration certificate. The first ID card C1 is not limited to a card-like one, and may be, for example, a sheet, a booklet, or a tag.

The first ID card C1 has a printing surface and an IC inlet. The individual number (My Number), written information, and a facial image (facial photo) are printed on the printing surface. The facial image is an example of pre-registered biometric information.

The individual number may also be referred to as, for example, a universal number, a individual indentification number, a social security number, a national insurance number or a national ID. The facial image may also be referred to as a face photo, image, picture, or diagram. The individual number, written information, and facial image may be printed in other locations, such as on the back side of the first ID card C1.

The individual number is a number assigned to the owner (user) of the first ID card C1. A facial image is a photograph that primarily captures the user's face. The individual number, written information, and facial image are information that have individuality that differs for each first ID card C1 issued.

The first ID card C1 can output information stored in a storage portion provided inside the card to an external device by electrical contact with the external device or without contact.

FIG. 7B is a plan view showing an example of a second ID card C2. The second ID card C2 may also be referred to as, for example, an information recording medium, a print medium, an authentication object, or an identification card.

The second ID card C2 is, for example, a driver's license. It should be noted that the second ID card C2 is not limited to this, and may be other ID cards such as a individual number card, an employee ID card, an insurance card, a passport, a bankbook, or a seal registration certificate. The second ID card C2 is not limited to a card-like one, and may be, for example, a sheet, a booklet, or a tag.

The second ID card C2 has a printing surface and an IC inlet. On the printing surface, written information and a facial image (facial photo) are printed.

The facial image may also be referred to as a face photo, image, picture, or diagram. The written information and the facial image may be printed in other locations, such as on the back side of the second ID card C2.

The written information may include, for example, character strings indicating the date of birth, name, and address of the owner (user) of the second ID card C2. A facial image is a photograph that primarily captures the user's face. The written information and the facial image are information that have individuality that differs for each second ID card C2 issued.

The second ID card C2 can output information stored in a storage portion provided inside the card to an external device by electrical contact with the external device or without contact.

As described above, the example embodiment provides increased convenience for passport applicants, but it also has advantages in terms of counter operations. For example, when there are a large number of applicants at the same time, operations at counters could become overwhelmed. This is expected to result in decentralization as some counter operations are replaced by delivery. In such a case, it is possible to reduce the workload of the counter staff.

In addition, it will be possible to replace the subjective judgment of the counter clerk in verifying that the recipient is the same as the applicant with an objective determination. This makes it possible to reduce variations in judgment.

According to at least the above example embodiment, the information processing system includes an acquisition portion that acquires biometric information about a subject, an authentication portion that authenticates the subject by using the acquired biometric information about the subject, and a control portion that causes information pertaining to the results of the authentication of the subject to be output to a delivery person who delivers a certificate possessing the biometric information about the subject, thereby making it possible to receive the certificate at a location other than the counter of a designated institution.

The information processing method in the information processing system and the computer program for executing the corresponding processing are also the same as those of the information processing system described above.

Some or all of the above-described example embodiments may be described as, but are not limited to, the following supplementary notes.

### Supplementary Notes

[1] An information processing system of one example aspect includes: an acquisition portion that acquires biometric information about a subject; an authentication portion that authenticates the subject by using the acquired biometric information about the subject; and a control portion that causes information pertaining to an authentication result of the subject to be output to a delivery person who delivers a certificate that possesses biometric information about the subject.
[2] In the information processing system of [1] above, the biometric information about the subject may include at least one of image information and acoustic information that enables individual identification of the subject.
[3] In the information processing system of [1] or [2] above, the acquisition portion may acquire an identification code attached to a packaging at a time of delivery of the certificate, and acquires the biometric information of the subject in response to an acquisition of the identification code, and the authentication portion may output a result of authentication as to whether or not a recipient of the certificate is an applicant for the certificate.
[4] In the information processing system of [2] above, the biometric information about the subject may include: first biometric information about the subject who has potential to be a recipient of the certificate; second biometric information about the subject obtained from a source other than the certificate; and third biometric information about the subject obtained from the certificate, and the authentication portion may authenticate the subject by using the first biometric information about the subject, the second biometric information about the subject, and the third biometric information about the subject.
[5] In the information processing system of [4] above, the authentication portion may authenticate the subject by using the first biometric information about the subject and the second biometric information about the subject, and authenticate the subject by using the first biometric information about the subject and the third biometric information about the subject.
[6] In the information processing system of [4] or [5] above, the authentication portion, in a case where authentication of the subject by using the first biometric information about the subject is unsuccessful, may authenticate the subject by using the second biometric information of the subject and the third biometric information of the subject.
[7] In the information processing system of [1] above, the biometric information about the subject may include fourth biometric information about the delivery person, the authentication portion may authenticate the delivery person by using the fourth biometric information about the delivery person, and if authentication of the delivery person is successful, may authenticate the subject by using the biometric information about the subject.
[8] In the information processing system of [7] above, the authentication portion may affirm a result of the authentication of the delivery person in a case where a first location where issuance of the certificate was applied for and a second location where the first biometric information about the subject was generated are within a predetermined distance range.
[9] An information processing method in an information processing system of one example aspect includes the process of: acquiring biometric information about a subject during a delivery stage; authenticating the subject by using the acquired biometric information about the subject; and causing information pertaining to an authentication result of the subject to be output to a delivery person who delivers a certificate that possesses biometric information about the subject.
[10] A program applicable to an information processing system of one example aspect is a program for causing a computer to execute the steps of:
acquiring biometric information about a subject during a delivery stage; authenticating the subject by using the acquired biometric information about the subject; and causing information pertaining to an authentication result of the subject to be output to a delivery person who delivers a certificate that possesses the biometric information about the subject.
[11] In the information processing system according to any one of [1] to [10] above, the authentication portion may be disposed in a computer in the cloud or in an edge computer.
[12] In the information processing system according to any one of [1] to [11] above, the biometric information of the subject may include information of any one of a face, an iris, a fingerprint, and a voice that enables individual identification of the subject.
[13] In the information processing system described in any of [1] to [12] above, the first biometric information about the subject may include image information obtained by photographing the subject who may be the recipient of the certificate at the delivery stage, the second biometric information about the subject may include image information of the subject obtained from a source other than the certificate (passport), and the third biometric information about the subject may include image information obtained from the certificate (passport).
[14] In the information processing system described in any of [1] to [13] above, the acquisition portion may acquire an identification code attached to the packaging at the time of delivery of the certificate, and acquire any of the information in response to acquiring the identification code, and the authentication portion may authenticate that the recipient of the certificate is the applicant, and output the result of the authentication.
[15] In the information processing system described in any of [1] to [14] above, the information pertaining to the results of the authentication of the subject may include either information indicating whether the authentication was successful or not, or information indicating whether the transfer of the certificate is permitted or not.
[16] In the information processing system described in any of [1] to [15] above, the cost processing portion, when the validity of delivering the certificate to the subject is confirmed by the authentication, may notify a payment processing device of a financial institution (credit company) of a request for settlement processing of the cost of the issuance and delivery processing.
[17] In the information processing system described in any of [1] to [16] above, when applying for a certificate, a first terminal used by an applicant and a second terminal of the related institution may be connected via videophone so as to be able to communicate with each other, and the first terminal may acquire a facial image of the applicant and a facial image on a driver's license presented by the applicant and send them to a device of the related institution, and the device of the related institution may acquire the facial image of the applicant and the facial image on the driver's license from the first terminal, collate the facial image of the applicant with the facial image on the driver's license, and send the result of thecollation to the second terminal for output.
[18] In the information processing system according to any one of [1] to [17] above, the certificate may be any one of a passport, a health insurance card, a residence card, an individual identification card, a driver's license, and a driver's license history certificate.

### REFERENCE SIGNS LIST

1, 610 Information processing system
410, 611 Acquisition portion
420, 612 Authentication portion
430, 613 Control portion
15 Storage portion
100 Applicant terminal device
200 Application processing device
300 Management device
400 Delivery person terminal device
500 Delivery information processing device
600 Terminal device
700 Payment processing device

What is claimed is:

1. An information processing system comprising:
a memory configured to store instructions; and
processing circuitry configured to execute the instructions to:
authenticate a subject based on biometric information of the subject; and
provide an authentication result to a device of a person delivering a certificate that includes the biometric information.

2. The information processing system according to claim 1,
wherein the biometric information includes at least one of image information that identifies the subject or sound information that identfies the subject.

3. The information processing system according to claim 1,
wherein the processing circuitry is configured to execute the instructions to:
acquire an identification code on packaging at of the certificate,;
acquire biometric information in response to acquiring the identification code; and
determine whether or not the subject is an applicant for the certificate based on the biometric information.

4. The information processing system according to claim 1,
wherein the biometric information includes:
first biometric information obtained from the subject while the person is delivering the certificate;
second biometric information of the subject obtained from a source other than the certificate;
third biometric information of the subject obtained from the certificate,
wherein the processing circuitry is configured to execute the instructions to authenticate the subject based on two or more of the first biometric information, the second biometric information, and the third biometric information.

5. The information processing system according to claim 4,
wherein the processing circuitry is configured to execute the instructions to authenticate the subject based on:
a first relationship between the first biometric information and the second biometric information, and
a second relationship between the first biometric information and the third biometric information.

6. The information processing system according to claim 4,
wherein the processing circuitry is configured to execute the instructions to, in a case where authentication of the subject based on the first biometric information is unsuccessful, authenticate the subject based on the second biometric information and the third biometric information.

7. The information processing system according to claim 1,
wherein the processing circuitry is configured to execute the instructions to
authenticate the person based on biometric information of the person, and
if authentication of the person is successful, authenticate the subject based on the biometric information of the subject.

8. The information processing system according to claim 7,
wherein the processing circuitry is configured to execute the instructions to:
confirm authentication of the subject based on a first location and a second location being within a predetermined distance,
wherein the first location corresponds to an address of the subject,
wherein the second location corresponds to a location where the first biometric information was acquired.

9. An information processing method comprising:
authenticating a subject based on biometric information of the subject; and
providing an authentication result to a device of a person delivering a certificate that includes the biometric information.

10. A non-transisory computer-readable recording medium storing a program for causing a computer to execute the steps of:
authenticating a subject on based biometric information of the subject; and
providing an authentication result to a device of a person delivering a certificate that includes the biometric information.

11. The information processing system according to claim 1, wherein the processing circuitry is disposed in a computer in the cloud or in an edge computer.

12. The information processing system according to claim 1, wherein the biometric information includes information of at least one of a face, an iris, a fingerprint, or voice that enables individual identification of the subject.

13. The information processing system according to claim 4,
wherein the first biometric information includes image information obtained by photographing the subject who has potential to be a recipient of the certificate while the certificate is delivered,
wherein the second biometric information includes image information of the subject obtained from a source different from the certificate, and
wherein the third biometric information includes image information obtained from the certificate.

14. The information processing system according to claim 1,
wherein the processing circuitry is configured to execute the instructions to acquire an identification code attached to a packaging in which the certificate is stored,
wherein the biometric information is information acquired in response to acquiring the identification code, and
wherein the processing circuitry is configured to execute the instructions to authenticate that a recipient of the certificate is an applicant for the certificate.

15. The information processing system according to claim 1, wherein information pertaining to the authentication result includes either: information indicating whether the authentication was successful or not; or information indicating whether transfer of the certificate to the subject is permitted or not.

16. The information processing system according to claim 1, wherein the processing circuitry is configured to execute the instructions to, in a case where validity of transfer of the certificate to the subject is confirmed by the authentication, notify a payment processing device of a financial institution of a request for settlement processing of a cost of issuance and/or delivery processing of the certificate.

17. The information processing system according to claim 1,
wherein a first terminal used by an applicant and a second terminal of a related institution are connected to each other via videophone so as to be able to communicate with each other while the certificate is applied by the applicant,
wherein the first terminal acquires a facial image of the applicant and a facial image on a driver's license presented by the applicant and send the acquired facial images to the related institution,
wherein the related institution acquires the facial image of the applicant and the facial image on the driver's license from the first terminal, compares the facial image of the applicant with the facial image on the driver's license, and sends a result of the comparison to the second terminal.

18. The information processing system according to claim 1, wherein the certificate is any one of a passport, a health insurance card, a residence card, an individual identification card, a driver's license, and a driver's license history certificate.

19. The information processing system according to claim 1, wherein the processing circuitry is configured to execute the instructions to authenticate the subject based on the first biometric information, the second biometric information, and the third biometric information.
